(19) United States
(12) Patent Application Publication
(10) Pub. No.: US 2024/0217851 A1
(43) Pub. Date: Jul. 4, 2024

(54) AUTONOMOUS VESSEL FOR TREATING ALGAE BLOOMS IN RESERVOIRS, COASTAL WATERWAYS, LAKES AND RIVERS

(71) Applicant: Prosper Technologies, LLC, Miami, FL (US)

(72) Inventors: Mark Max MacKenzie, Miami, FL (US); David Wade Campbell, Miami, FL (US)

(21) Appl. No.: 18/542,363

(22) Filed: Dec. 15, 2023

Related U.S. Application Data
(60) Provisional application No. 63/435,954, filed on Dec. 29, 2022.

(51) Int. Cl. C02F 1/72; C02F 1/32; C02F 101/12; C02F 101/16; C02F 103/00; C02F 103/08

(52) U.S. Cl. CPC C02F 1/727; C02F 1/32; C02F 2101/12; C02F 2101/16; C02F 2103/007; C02F 2103/08; C02F 2201/001; C02F 2201/009; C02F 2209/04; C02F 2209/05; C02F 2209/06; C02F 2209/10; C02F 2209/16; C02F 2209/22; C02F 2301/046; C02F 2303/04

(57) ABSTRACT

An autonomous water treatment system can include a vessel comprising one or more thrusters, a base, and a dome. The base and the dome can form a housing when attached to each other, and the thrusters can be configured to rotate to steer the vessel. The treatment system can include solar panels mounted on an exterior surface of the dome, and batteries disposed inside the housing. The batteries can be recharged by energy generated by the solar panels. The treatment system can include a gas infusion system disposed inside in the housing. The gas infusion system can be configured to receive a flow of water from a body of water, infuse said flow of water with oxygen, remove dissolved nitrogen from said flow of water, and return the oxygen infused water to the body of water under pressure to propel the vessel along the body of water.

### INCORPORATION BY REFERENCE TO ANY PRIORITY APPLICATIONS

This application claims priority to U.S. Provisional Patent Application No. 63/435,954, filed Dec. 29, 2022, which is hereby incorporated by reference in its entirety.

### BACKGROUND OF THE INVENTION

### Field

The present disclosure relates to systems and method for treating surface water systems with gas infusion, and more particularly to autonomous systems and methods for treating algae blooms in bodies of water (e.g., ponds, lakes, rivers, coastal waterways, ocean).

### Description of the Related Art

Algal blooms in surface water systems (e.g., caused by the presence of large amounts of nitrogen and phosphorous in water, such as due to nitrogen runoff from fertilizers and other pollutants, such as discharges from sewage treatment plants) are extremely detrimental to aquatic ecosystems. Algae produce oxygen during the day through photosynthesis, but during the night they consume more oxygen than they produce. This can result in oxygen starvation (e.g., anoxia, hypoxia) of the surface water system, causing a toxic environment for microorganisms and fish, leading to fish die-offs. Birds and mammals that survive on the fish can also become ill when consuming such fish and lose their food source, leading to an ecosystem collapse and an algal takeover of the lake, pond, bay, and other marine environments. Additionally, bacteria such as cyanobacteria, chlorophyll, and hydrogen sulfide can be present in such bodies of water.

### SUMMARY

In accordance with one aspect of the disclosure, an efficient and cost effective autonomous and chemical-free system and method for inhibiting (e.g., preventing) or reversing the conditions that cause harmful algal blooms in bodies of water (e.g., fresh water or salt water bodies of water) to thereby provide a balanced and healthy aquatic environment.

In accordance with one aspect of the disclosure, an autonomous vessel is provided for use in a body of water (e.g., fresh water or salt water body of water) for inhibiting (e.g., preventing) or reversing the conditions that cause harmful algal blooms. The autonomous vessel includes an oxygen generator, a gas infusion system and a pump. The pump is operable to pump (via an intake or inlet conduit) water from the body of water through the gas infusion system to infuse said water with oxygen generated by the oxygen generator and to simultaneously remove nitrogen from said water, the pump returning the oxygen infused water to the body of water (via an outlet conduit) downstream of the gas infusion system that advantageously propels the vessel along the body of water. The autonomous vessel is self-powered. In one example, the oxygen generator and pump are powered with one or more of a plurality of solar panels on the barge and one or more rechargeable batteries. In another example, a generator (e.g., diesel generator) can alternatively or additionally be used to provide power to the oxygen generator and pump and for vessel propulsion (e.g., at night or when the solar panels, wind turbines and batteries provide insufficient power to operate the oxygen generator and pump). The barge can include a controller (e.g., a programmable logic controller or PLC) operable to operate the oxygen generator and pump and that can wirelessly communicate with a docking station and/or a base station, and via which the computer transfers sensed data from the water treatment process and receives instructions (e.g., trajectory instructions for directing the vessel along the body of water). The vessel can have one or more sensors for sensing one or more parameters of the water (e.g., in the intake conduits, in the outlet conduits), such as dissolved oxygen level, nitrogen level, pH, etc. and the sensed data can be stored in a memory (e.g., a computer memory in communication with the PLC) or wirelessly communicated to a base station via a cloud wireless communication system.

In some aspects, the techniques described herein relate to an autonomous water treatment system including: a vessel including one or more thrusters, a base, and a dome, wherein the base and the dome form a housing when attached to each other, and wherein the thrusters are configured to rotate along an axis to steer the vessel; one or more solar panels mounted on an exterior surface of the dome; one or more batteries disposed inside the housing, wherein the one or more batteries are recharged by energy generated by at least one of the one or more solar panels; and a gas infusion system disposed inside in the housing, the gas infusion system configured to receive a flow of water from the body of water, to infuse said flow of water with oxygen and to simultaneously remove dissolved nitrogen from said flow of water, and to return the oxygen infused water to the body of water under pressure to propel the vessel along the body of water.

### BRIEF DESCRIPTION OF THE DRAWINGS

FIGS. 1A-1E show an example of a water treatment system including an autonomous vessel.

FIGS. 2 and 3 show an example of a gas infusion system for use in the water treatment system shown in FIGS. 1A-1E.

FIGS. 4A-5 show an example of a gas infusion module for use in the gas infusion system shown in FIGS. 2 and 3.

### DETAILED DESCRIPTION

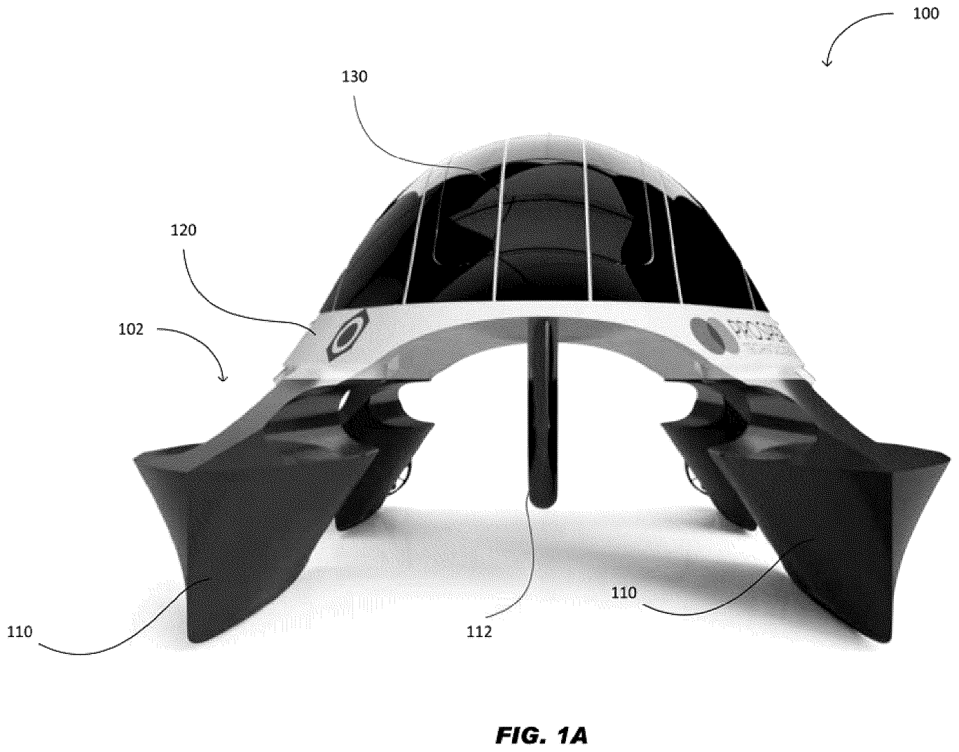

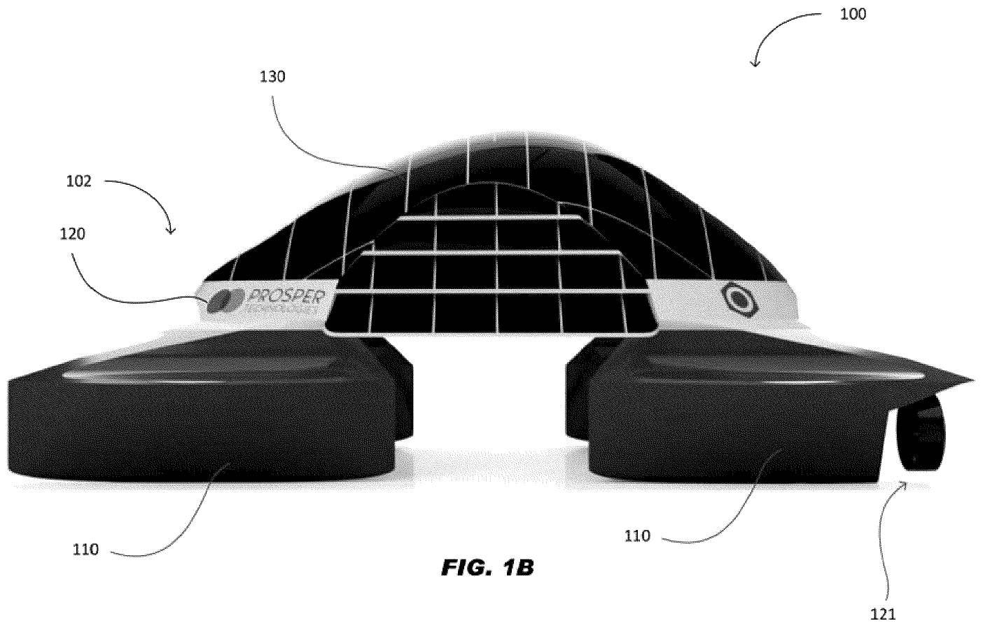

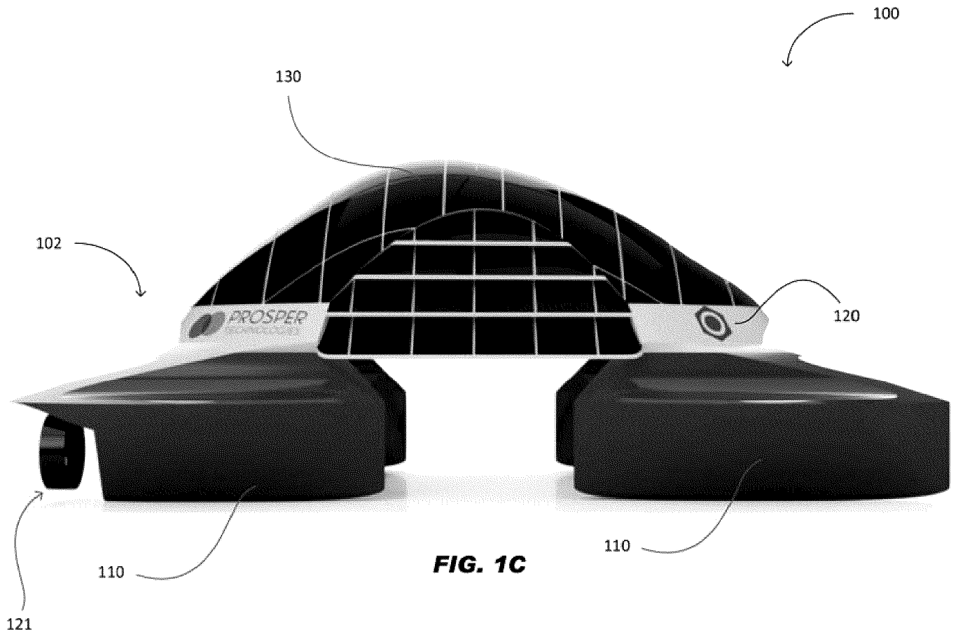

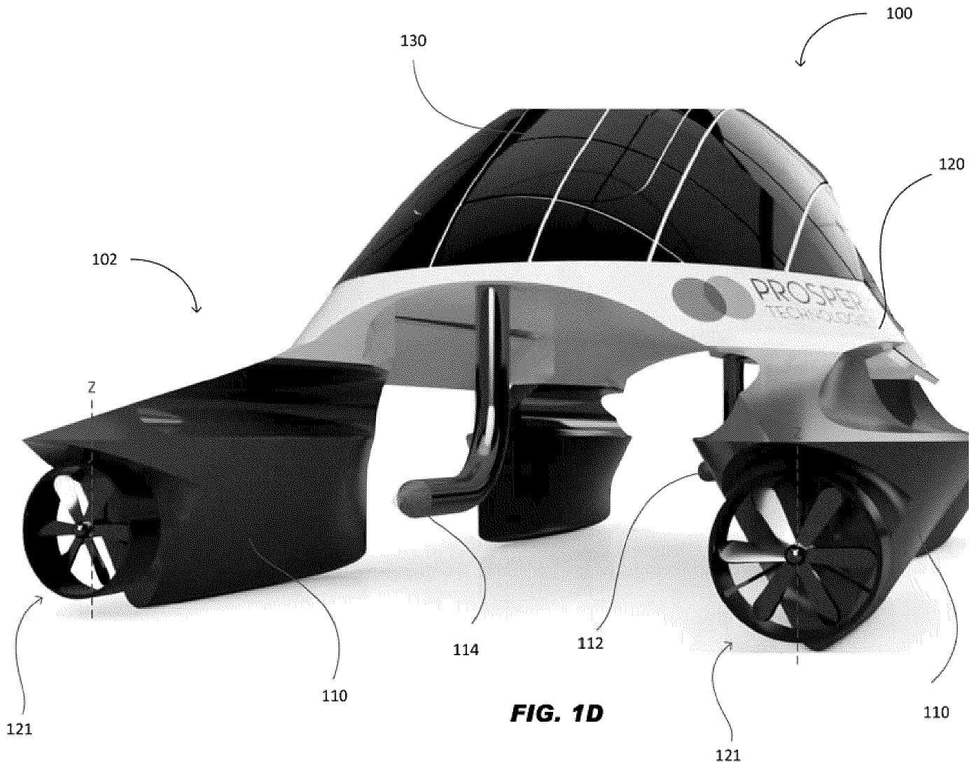

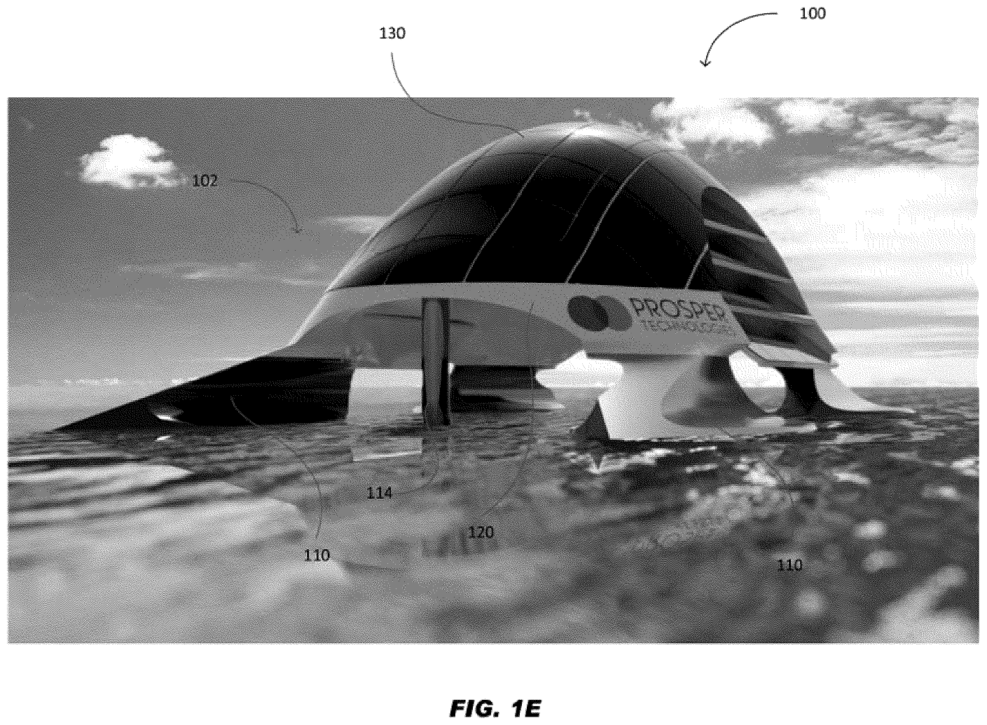

FIGS. 1A-1E show an example of a treatment system (e.g. an autonomous water treatment system). The treatment system 100 can be used to inhibit (e.g., prevent) or treat (e.g., reverse) algae blooms in surface water systems (e.g., bodies of water such as coastal waterways, ponds, lakes, rivers, etc.) by infusing such water with dissolved oxygen in a bubbleless manner. The treatment system 100 can include a vessel 102 (e.g., an autonomous vessel). The vessel 102 can include a base 110 and a dome 120 that can be attached to the base 110 to form a housing. The base 110 and the dome 120 can form a watertight seal (also referred herein to as a fluid tight seal) when attached to each other. For example, the base 110 and the dome 120 can form a watertight seal around an edge where the base 110 and the dome 120 attach to each other. The vessel 102 can also include one or more thrusters 121 mounted to the base 110. The thrusters 121 can beneficially rotate along a Z-axis (e.g., a vertical axis) to facilitate steering of the vessel 102 in more than one direction. In one implementation, the thrusters 121 do not propel the vessel 102, only provide a steering capability for the vessel 102. The treatment system 100 can also include an inlet conduit 112 and an outlet conduit 114. One or more solar panels 130 can be mounted to the dome 120 (e.g., on an exterior surface of the dome 120) around the circumference of the dome 120 (e.g. along an entire surface of the dome 120, including all sides and a top of the dome 120), to thereby advantageously generate solar electricity irrespective of the position of the sun relative to the vessel 102 and without having to reposition the vessel 102 for the solar panels 130 to receive sunlight. In one example, the solar panels 130 can be flexible solar panels. In one example, shown in FIGS. 1A-1E, the solar panels 130 can define a contoured (e.g., curved) surface. In another implementation, the vessel 102 can also include one or more wind turbines (not shown) to generate electricity. As shown in FIG. 1E, an orientation of one or more of the solar panels 130 can be adjusted to allow airflow into the compartment between the dome 120 and the base 110 that houses the gas infusion equipment, such as the pump and batteries, to cool such components in said compartment with the airflow and inhibit their overheating, thereby inhibiting (e.g., preventing) the need for maintenance of replacement of said components and prolonging their working life.

The treatment system can also include a gas infusion system 150, one or more batteries, and one or more wireless chargers. In some implementations, the gas infusion system 150, one or more batteries, and one or more wireless chargers can be disposed inside the housing formed by the base 110 and the dome 120 (e.g., mounted on a platform within the housing formed by the base 110 and the dome 120). The inlet conduit 112 and the outlet conduit 114 can be in fluid connection with the gas infusion system 150. In some implementations, the vessel 102 can freely move in a body of water, as further discussed below, for delivery of oxygen infused water to more than one location in the body of water (e.g., to specified GPS locations within the body of water, causing additional aeration and mixing because of the movement of the vessel 102 itself.

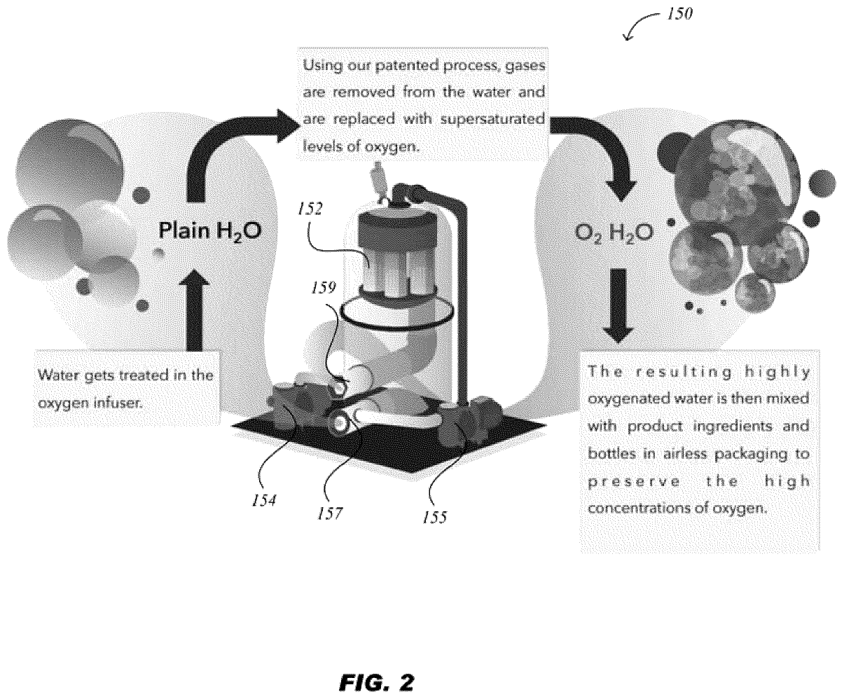

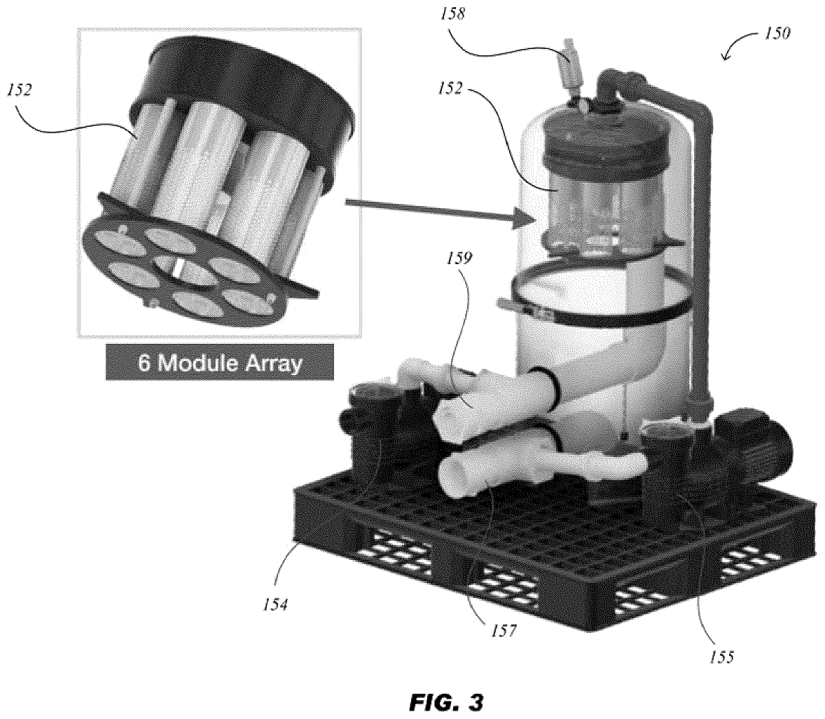

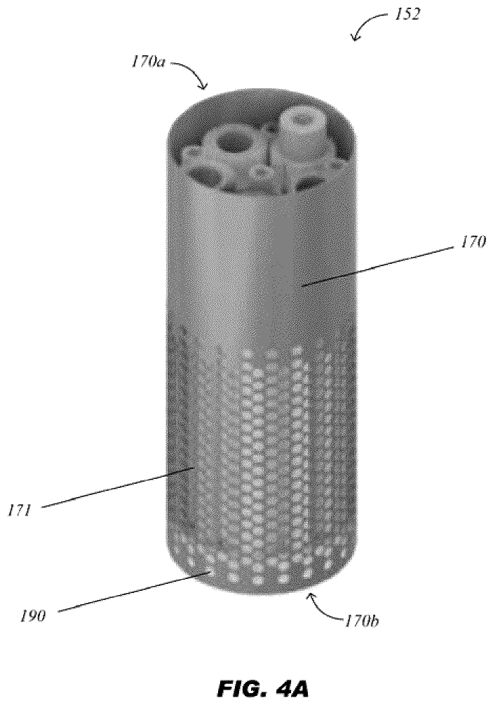

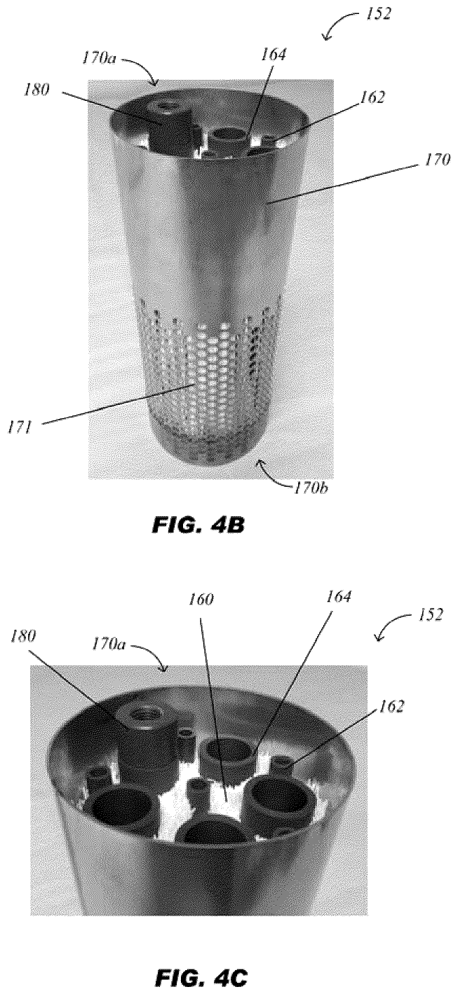

The gas infusion system 150, as shown in FIGS. 2 and 3, can include one or more gas infusion modules 152 (shown in FIG. 4A) which can infuse a gas, such as oxygen, into the liquid (e.g., water), in a bubbleless manner to thereby increase the dissolved oxygen level of said water (e.g., supersaturated oxygen levels of over 60 ppm, such as 200 ppm). Advantageously, along with infusing the water with oxygen, the gas infusion modules can simultaneously and instantaneously remove dissolved gases from the water, such as, for example, nitrogen and carbon dioxide, which are vented to atmosphere. Each gas infusion module 152 can include a bundle of narrow diameter, microporous hollow fibers (MHF). Further details of the structure and operation of the gas infusion modules can be found in International Application No. PCT/US2023/076987, titled METHOD FOR ATTACHING FIBERS TO A POTTING MOLD FOR A GAS INFUSION MODULE, which was filed on Oct. 16, 2023, and which is incorporated herein by reference in its entirety.

As shown in FIGS. 4B-4C, each of the gas infusion modules 152 can include one or more fibers 160. The fibers 160 can include a micro-porous hollow fiber. The fibers 160 can include one or more sheets, layers, and/or bundles that can be wrapped around one or more cores 162, 164. The gas infusion module 152 can also include a shell 170. The shell 170 can include a stainless-steel material (e.g., 316 stainless steel); however, the shell 170 can be made of other suitable materials (e.g., other suitable metals). The shell 170 can have an outer diameter of about 4 inches, in one example. In some cases, the shell 170 incudes a plurality of perforations 171 extending at least partially between a first end 170a and a second end 170b of the shell 170. In the illustrated implementation, the perforations 171 are on about ½ or more of the length of the shell 170. The perforations 171 extend completely through the wall of the shell 170, allowing flow through the perforations 171 from outside the shell 170 to inside the shell 170. The perforations 171 can allow the water flowing through the gas infusion system 150 to access an interior portion of the shell 170. This can beneficially allow the water flowing through the gas infusion system 150 to contact the fibers 160 inside each of the gas infusion modules 152 and, as further described below, oxygenate the water as the water flows through gas infusion modules 152.

In some cases, the cores 162, 164 can include cylindrical tubes. The core 164 can include an outer diameter larger than an outer diameter than the core 162. In some cases, each of the gas infusion modules 152 can include six cores 162 and five cores 164. However, the gas infusion module 152 can include other combinations of cores 162, 164. In some cases, the cores 162, 164 can include a Polyvinyl chloride (PVC) material; however, the cores 162, 164 can be made of other suitable materials (e.g., other plastics, a metal). In some cases, a seal 190 can be positioned along the second end 170b of the shell 170. The seal 190 can include an epoxy material. The seal 190 can be spaced from the cores 162, 164 and/or the fibers 160 so there is a gap between the seal and the cores 162, 164 and/or the fibers 160. In some cases, the seal 190 can include a hole. The hole can provide fluid communication between the gap and the exterior of the gas infusion module 152.

Each of the gas infusion modules 152 can include a connection port 180 attached to a core 164. In some cases, the connection port 180 can include a thread along an interior portion of the connection port 180. The thread can facilitate connection of the connection port 180 to a source of gas (e.g., oxygen). For example, the connection port 180 can be in fluid communication with an oxygen generator 158. The connection port 180 can be attached to the core 164. Beneficially, this can allow the gas to flow the entire length of the core 164 thereby oxygenating the fibers 160 of the gas infusion module 152. For example, the gas can be injected to the gas infusion module 152 via the connection port 180 and flow the entire length of the core 164 the connection port 180 is attached to. The gas can exit the core 164 via the drilled hole and then flow through the gap between the seal 190 and the cores 162, 164 and/or the fibers 160.

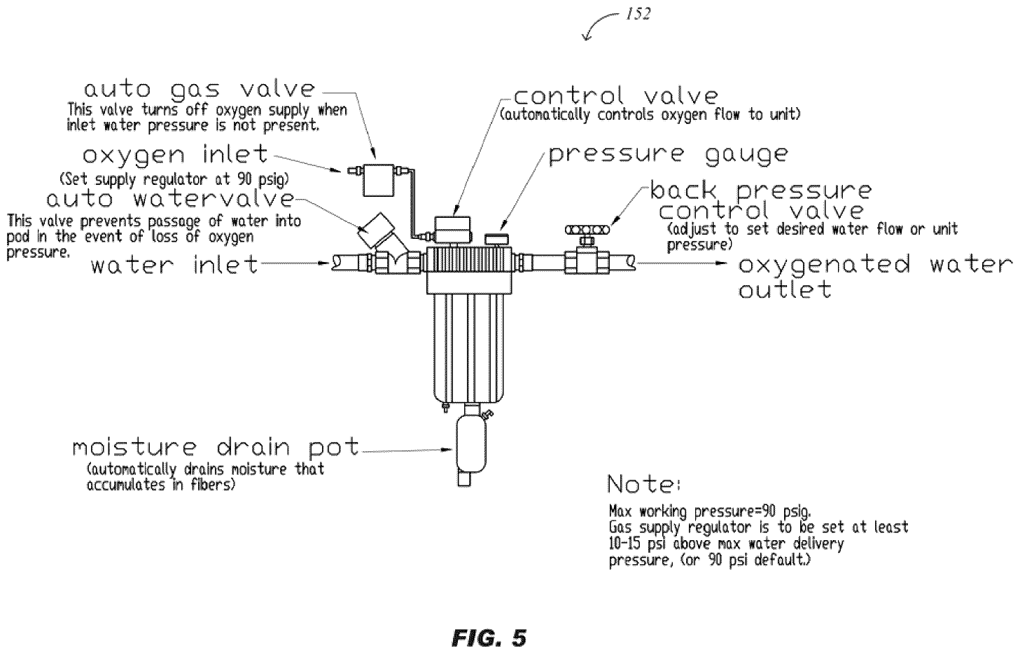

As shown in FIG. 5, the gas infusion modules 152 can include a gas valve, a control valve, a pressure gauge, a back pressure control valve, an oxygenated water outlet, a moisture drain pot, a water inlet, an automatic water valve, and an oxygen inlet operatively coupleable to an oxygen generator (e.g., that generates oxygen at greater than 90% purity, such as about 95% purity). The gas valve prevents the flow of gas when water pressure is lost or reduced. In some examples, the moisture drain pot can drain and collect moisture accumulated on the fibers of the gas infusion module 152. The automatic water valve can beneficially prevent the flow of water when oxygen pressure is reduced or lost. The gas infusion system 150 can include one or more circulation pumps 154, recirculation pump 155, filters, an oxygen generator 158, an inlet conduit 157, and an outlet conduit 159. The inlet conduit 157 can be in fluid communication with the inlet conduit 112, and the outlet conduit 159 can be in fluid communication with the outlet conduit 114. In some implementations, the recirculation pump is excluded and the gas infusion system 150 only has the circulation pump 154 (e.g., only has one pump).

The oxygen generator 158 can supply a gas with a concentration of less than or at least 94% oxygen. The gas supplied by the oxygen generator 158 can be injected to each gas infusion module 152 so that the oxygen flows through each of the microporous hollow fibers, the water flowing through the module(s) 152 so that the water surrounds the microporous hollow fibers, the oxygen transferred passively via pores of the fibers to the water and nitrogen (and carbon dioxide) transferred from the water to the hollow conduit of the fibers via the pores. The removed nitrogen (and other gases, such as carbon dioxide) are thereafter vented to the atmosphere by the gas infusion system 150. The gas can be injected to each gas infusion module 152, for example, via a central cavity of the gas infusion modules 152. Liquid (e.g., water) can flow into the gas infusion modules 152 of the gas infusion system 150 via the inlet conduits 112 and 157. In some examples, the pump 154 can facilitate the flow of liquid from a body of water to the gas infusion system 150. The pump 154 can in one example be a 12-volt 0.5 horsepower (373 W) pump. The use of the microporous hollow fibers advantageously allows the oxygen particles flowing though the fibers of the gas infusion modules 152 to transition from a gas phase to a liquid phase as they flow through the pores of the fibers and into the water without the formation of bubbles. Nitrogen and other dissolved gases (e.g., carbon dioxide) are advantageously simultaneously and automatically removed from the water via said pores of the fibers and released to the atmosphere. The pump advantageously provides a flow rate through the gas infusion system 150 and out of the outlet conduit 114 that provides propulsion to the vessel 102. Although the gas infusion system 150 shown in FIG. 3 includes six gas infusion modules, the gas infusion system 150 can include less than or more than six gas infusion modules (e.g., one, two, three, four, five, seven, eight, etc.). The liquid can exit the treatment system 100 and return to the body of water via the outlet conduits 114 and 159. In some cases, the liquid can flow though the gas infusion system 150 more than one time (e.g., be recirculated when a recirculation pump 155 is used), for example to achieve higher oxygen infusion levels in the water. The recirculation pump 155 can facilitate recirculation of the liquid through the gas infusion system 150. Advantageously, the vessel 102 can be propelled by the outflow of oxygenated water flowing out of the outlet conduit 159 and 114.

In some implementations, the treatment system 100 can also include an ultraviolet (UV) treatment system. The UV treatment system can beneficially remove chlorine and chloramines, and/or destroy pathogens present in the water. The UV treatment system can be positioned downstream of the gas infusion modules 152. For example, once the water exits the gas infusion system 150 via the outlet conduit 159, said water can pass through the UV treatment system before returning to the body of water via the outlet conduit 114.

One or more batteries (e.g., four 12 V rechargeable batteries) can be disposed inside the housing formed by the base 110 and a dome 120. The batteries can include lithium-ion batteries. The batteries can be used to power, for example, the vessel 102 and the gas infusion system 150 and its components (e.g., oxygen generator 158, circulation pumps 154, recirculation pump 155, PLC, etc.). The batteries can beneficially be recharged. The energy produced by the one or more solar panels 130 can be used to recharge the batteries. In another implementation, the solar panels 130 and wind turbines 140 can directly power the components (e.g., pump 154, recirculation pump 155, oxygen generator 158, PLC, etc.) of the gas infusion system 150 instead of or in addition to directing power to the batteries to recharge the batteries.

In some implementations, the treatment system 100 can include a computer (e.g., a programmable logic computer or controller PLC). The computer can control the treatment system 100, monitor the status of the treatment system 100, and/or communicate with other devices. The computer can include a wireless connection module, a processor, and a memory. The wireless connection module can receive and send instructions and/or information to other devices. In some examples, the wireless communication module can receive instructions from an electronic device (cellphone, computer, etc.) in communication with the wireless connection module. The instructions can include instructions for controlling the path and/or movement of the vessel 102. The instructions received by the wireless communication module can be processed by the processor which can cause the vessel 102 to start moving, stop moving, change course, follow a predefined route, etc.

The wireless connection module can, in some cases, include an antenna which can communicate via a 3G, 4G or 5G connection. For example, the computer (e.g., PLC) of the vessel 102 can receives wireless instructions via the wireless connection on the trajectory for the vessel 102, thereby allowing the vessel 102 to be operated remotely. The computer (e.g., PLC) can also wirelessly communicate with the docking station, and can wirelessly communicate with a base station over a cloud service (e.g., to send data to the base station). The computer (e.g. PLC) can also include one or more sensors that can collect information relating (e.g., sense one or more parameters) to the status of the treatment system 100. For example, the sensors can collect information relating to the remaining charge of the batteries, water quality before and after flowing through the gas infusion system 150 (e.g., oxygen level, nitrogen level, phosphorus level, pH, ORP, TSS, salinity, etc.). The treatment system 100 can also include systems with GPS, LIDAR, and sonar capabilities which can beneficially facilitate locating and/or tracking the vessel 102, program the path of the vessel 102, and/or avoid environmental obstacles. The computer can include the GPS, LIDAR, and sonar capable systems. The memory can store the sensor and/or positional data, for example when it is not possible for the computer (e.g., PLC) to wirelessly communicate the data to the base station. The sensor and positional data stored in the memory can be wirelessly transmitted using a cloud system. The sensor and positional data can also be shared to a land-based controller using a wired connection.

A docking station can act as a service station for the treatment system 100. In some cases, the docking station can include a housing, batteries, solar panels, and wind turbines. The batteries (e.g., eight 12 V rechargeable batteries, such as lithium ion batteries) of the docking station can be recharged using the solar panels and/or turbines. In one implementation, the solar panels of the docking station can be rigid solar panels (e.g., 16 solar panels providing 375 W each), and the docking station sized to allow the vessel 102 to enter the docking station. The vessel 102 can beneficially navigate into the docking station to get serviced. For example, when anchored to the docking station, the batteries of the docking station can recharge the batteries of the vessel 102 that provide power to the components of the treatment system 100 (e.g., the pump, the oxygen generator), and/or the batteries of the treatment system 100 can be replaced with batteries on the docking station. In some implementations, the docking station can include wireless chargers for transferring energy from the batteries on the docking station to the batteries of the treatment system 100. The docking station can beneficially provide security (e.g., shield from tampering) and protection from the elements (e.g., bad weather) when the vessel 102 is inside the housing of the docking station. The docking station can be positioned near the location of the treatment system 100. The docking station can be positioned at or near the shore, or on the water (as a floating station).

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. An autonomous water treatment system comprising:
a vessel comprising one or more thrusters, a base, and a dome, wherein the base and the dome form a housing when attached to each other, and wherein the one or more thrusters are configured to rotate along an axis to steer the vessel;
one or more solar panels mounted on an exterior surface of the dome;
one or more batteries disposed inside the housing, wherein the one or more batteries are recharged by energy generated by at least one of the one or more solar panels; and
a gas infusion system disposed inside in the housing, the gas infusion system configured to receive a flow of water from a body of water, to infuse said flow of water with oxygen and to simultaneously remove dissolved nitrogen from said flow of water, and to return the oxygen infused water to the body of water under pressure to propel the vessel along the body of water.

2. The autonomous water treatment system of claim 1, wherein the housing includes a watertight seal around an edge where the base and the dome attach to each other.

3. The autonomous water treatment system of claim 1, wherein the gas infusion system comprises a plurality of gas infusion modules, a circulation pump, and recirculation pump.

4. The autonomous water treatment system of claim 3, wherein the plurality of gas infusion modules comprise a plurality of microporous hollow fibers, and wherein the pressurized oxygen is injected into the flow of water via the plurality of microporous hollow fibers.

5. The autonomous water treatment system of claim 1, further comprising an ultraviolet treatment (UV) system disposed downstream of the gas infusion system and configured to destroy at least one of a chlorine, chloramines, and a pathogen from said flow of water before returning the flow of water to the body of water.

6. The autonomous water treatment system of claim 1, further comprising a plurality of sensors for monitoring one or more parameters of the water.

7. The autonomous water treatment system of claim 6, wherein the one or more parameters include at least one of an oxygen level, nitrogen level, phosphorus level, pH, ORP, TSS, and salinity.

8. The autonomous water treatment system of claim 1, further comprising a position system for tracking and monitoring a position of the vessel.

9. The autonomous water treatment system of claim 8, wherein the position system includes a system having at least one of a GPS, LIDAR, and sonar capability.

10. The autonomous water treatment system of claim 1, wherein the one or more batteries can be wirelessly recharged when the vessel is anchored to a docking station.

11. An autonomous water treatment system comprising:
a vessel comprising one or more thrusters, a base, and a dome, wherein the base and the dome form a housing when attached to each other, and wherein the one or more thrusters are configured to rotate along an axis to steer the vessel;
one or more flexible solar panels mounted on an exterior surface of the dome and defining a contoured surface;
one or more batteries disposed inside the housing, wherein the one or more batteries are recharged by energy generated by at least one of the one or more solar panels; and
a gas infusion system disposed inside in the housing, the gas infusion system configured to receive a flow of water from a body of water, to infuse said flow of water with oxygen and to simultaneously remove dissolved nitrogen from said flow of water, and to return the oxygen infused water to the body of water under pressure to propel the vessel along the body of water.

12. The autonomous water treatment system of claim 11, wherein the housing includes a watertight seal around an edge where the base and the dome attach to each other.

13. The autonomous water treatment system of claim 11, wherein the gas infusion system comprises a plurality of gas infusion modules, a circulation pump, and recirculation pump.

14. The autonomous water treatment system of claim 13, wherein the plurality of gas infusion modules comprise a plurality of microporous hollow fibers, and wherein the pressurized oxygen is injected into the flow of water via the plurality of microporous hollow fibers.

15. The autonomous water treatment system of claim 11, further comprising an ultraviolet treatment (UV) system disposed downstream of the gas infusion system and configured to destroy at least one of a chlorine, chloramines, and a pathogen from said flow of water before returning the flow of water to the body of water.

16. The autonomous water treatment system of claim 11, further comprising a plurality of sensors for monitoring one or more parameters of the water.

17. The autonomous water treatment system of claim 16, wherein the one or more parameters include at least one of an oxygen level, nitrogen level, phosphorus level, pH, ORP, TSS, and salinity.

18. The autonomous water treatment system of claim 11, further comprising a position system for tracking and monitoring a position of the vessel.

19. The autonomous water treatment system of claim 18, wherein the position system includes a system having at least one of a GPS, LIDAR, and sonar capability.

20. The autonomous water treatment system of claim 11, wherein the one or more batteries can be wirelessly recharged when the vessel is anchored to a docking station.
